(19) United States
(12) Patent Application Publication
(10) Pub. No.: US 2016/0212214 A1
(43) Pub. Date: Jul. 21, 2016

(54) TUNNELED REMOTE DIRECT MEMORY ACCESS (RDMA) COMMUNICATION

(71) Applicant: Avago Technologies General IP (Singapore) Pte. Ltd., Singapore (SG)

(72) Inventors: Masoodur Rahman, Austin, TX (US); Aravinda Venkatramana, Austin, TX (US); Parav K. Pandit, Bangalore (IN)

(21) Appl. No.: 14/996,988

(22) Filed: Jan. 15, 2016

Related U.S. Application Data
(60) Provisional application No. 62/104,635, filed on Jan. 16, 2015.

(51) Int. Cl. H04L 29/08; H04L 12/863

(52) U.S. Cl. CPC H04L 67/1097; H04L 47/6295

(57) ABSTRACT

Tunneling packets of one or more remote direct memory access (RDMA) unreliable queue pairs of a first adapter device through an RDMA reliable connection (RC) by using RDMA reliable queue context and RDMA unreliable queue context stored in the first adapter device. The RDMA reliable connection is initiated between a first RDMA RC queue pair of the first adapter device and a second RDMA RC queue pair of a second adapter device. The RDMA reliable queue context is for the first RDMA RC queue pair, and the RDMA unreliable queue context is for the one or more RDMA unreliable queue pairs of the first adapter device.

### CROSS-REFERENCE TO RELATED APPLICATIONS

This non-provisional United States (U.S.) patent application claims the benefit of U.S. Provisional Patent Application No. 62/104,635 entitled RELIABLE REMOTE DIRECT MEMORY ACCESS (RDMA) COMMUNICATION filed on Jan. 16, 2015 by inventors Rahman et al.

### FIELD

The embodiments relate generally to reliable remote direct memory access (RDMA) communication.

### BACKGROUND

Virtualized server computing environments typically involve a plurality of computer servers, each including a processor, memory, and network communication adapter coupled to a computer network. Each computer server is often referred to as a host machine that runs multiple virtual machines (sometimes referred to as guest machines). Each virtual machine typically includes software of one or more guest computer operating system (OS). Each guest computer OS may be any one of a Windows OS, a Linux OS, an Apple OS, and the like, with each OS running one or more applications.

In addition to each guest OS, the host machine often executes a host OS and a hypervisor. The hypervisor typically abstracts the underlying hardware of the host machine, and time-shares the processor of the host machine between each guest OS. The hypervisor may also be used as an Ethernet switch to switch packets between virtual machines and each guest OS. The hypervisor is typically communicatively coupled to a network communication adapter to provide communication to remote client computers and to local computer servers.

Because there is often no direct communication between each guest OS, the hypervisor typically allows each guest OS to operate without being aware of other guest OSes. Each guest OS operating may appear to a client computer as if it is the only OS running on the host machine.

A group of independent host machines (each configured to run a hypervisor, a host OS, and one or more virtual machines) can be grouped together into a cluster to increase the availability of applications and services. Such a cluster is sometimes referred to as a hypervisor cluster, and each host machine in a hypervisor cluster is often referred to as a node.

In computing environments that perform remote direct memory access (RDMA) communication, RDMA traffic can be communicated by using RDMA queue pairs (QP) that provide reliable communication (e.g., RDMA reliable connection (RC) QP's), or by using RDMA QPs that do not provide reliable communication (e.g., RDMA unreliable connection (UC) QPs or RDMA unreliable datagram (UD) QPs).

### BRIEF SUMMARY

Embodiments disclosed herein are summarized by the claims that follow below. However, this brief summary is being provided so that the nature of this disclosure may be understood quickly.

As described above, RDMA traffic can be communicated by using RDMA RC QP's, or by using RDMA QPs that do not provide reliable communication. RDMA RC QP's provide reliability across the network fabric and the intermediate switches, but consume more memory in the host as well as in the network adapter as compared to unreliable QPs. Although unreliable QPs do not provide reliable communication, they may consume less memory in the host and in the network adapter, and also may scale better than RC QPs.

Memory consumption of RC QP's is of particular concern in clustered systems in virtual server computing environments that have multiple RDMA connections between two nodes. For example, the connections originate from different virtual machines in a Para-virtualized environment of one node which target the same remote node in the cluster. Using RC QP's for each such connection can impact scalability and cost.

As one example, in a NFV (Networking Functions Virtualization) environment, multiple VNFs (Virtualized Network Functions) can communicate with a same HSS (Home Subscriber Server) for subscriber information or a same PCRF (Policy Charging Rules Function) for Policy and QoS (Quality of Service) information. Each of the VNFs can be implemented in a virtual machine on the same physical server, and the HSS can reside on a different physical node. This arrangement can result in multiple RDMA connections to transfer the data, which can increase offload requirements on the network adapters.

As another example, Virtualized Hadoop clusters using Map-Reduce can have mappers implemented in VMs (Virtual Machines) in a single physical node. The reducers can also be implemented in VMs in a separate physical node. The shuffle may need connectivity between mappers and reducers, thereby leading to multiple connections between two physical nodes, which can increase offload requirements on the network adapters.

It is desirable to reduce memory consumption and cost of reliable RDMA communication between nodes.

This need is addressed by tunneling unreliable RDMA communication through a single reliable connection that is established between two nodes. In this manner, only one RC QP context is maintained across multiple unreliable QP connections between two nodes.

In an example embodiment, packets of one or more remote direct memory access (RDMA) unreliable queue pairs of a first adapter device are tunneled through an RDMA reliable connection (RC) by using RDMA reliable queue context and RDMA unreliable queue context stored in the first adapter device. The RDMA reliable connection is initiated between a first RDMA RC queue pair of the first adapter device and a second RDMA RC queue pair of a second adapter device. The RDMA reliable queue context is for the first RDMA RC queue pair, and the RDMA unreliable queue context is for the one or more RDMA unreliable queue pairs of the first adapter device.

By virtue of the foregoing arrangement, memory consumption in both the node and the adapter device can be reduced.

According to an aspect, the RDMA unreliable queue pairs include at least one of RDMA unreliable connection (UC) queue pairs and RDMA unreliable datagram (UD) queue pairs.

According to another aspect, the reliable queue context includes transport context for all unreliable RDMA traffic between one or more RDMA unreliable queue pairs of the first adapter device and one or more RDMA unreliable queue pairs of the second adapter device, and the transport context includes connection context for the reliable connection.

According to another aspect, each tunneled RDMA unreliable queue pair packet includes a tunnel header that includes an adapter device opcode that indicates that the packet is tunneled through the reliable connection, and includes information for the reliable connection. The tunnel header can include a queue pair identifier of the second RDMA RC queue pair of the second adapter device.

According to an aspect, the RDMA unreliable queue context for each RDMA unreliable queue pair contains an identifier that links to the RDMA reliable queue context, wherein the RDMA reliable queue context includes a connection state of the reliable connection, and a tunnel identifier that identifies the reliable connection. RDMA reliable queue context corresponding to an RDMA UC queue pair can include connection parameters for an unreliable connection of the RDMA UC queue pair. RDMA reliable queue context corresponding to a RDMA UD queue pair can include a destination address handle of the RDMA UD queue pair. The tunnel identifier can be a queue pair identifier of the first RDMA RC queue pair.

According to an aspect, the reliable connection is an RC tunnel for tunneling unreliable RDMA traffic between one or more RDMA unreliable queue pairs of the first adapter device and one or more RDMA unreliable queue pairs of the second adapter device.

According to another aspect, the first adapter device includes an RDMA transport context module constructed to manage the RDMA reliable queue context, and an RDMA queue context module constructed to manage the RDMA unreliable queue context. The adapter device uses the RDMA transport context module to access the RDMA reliable queue context and uses the RDMA queue context module to access the unreliable queue context during tunneling of packets through the reliable connection.

According to an aspect, the RDMA unreliable queue context for each RDMA unreliable queue pair contains a send queue index, a receive queue index, RDMA protection domain information, queue key information, and event queue element (EQE) generation information.

According to another aspect, the RDMA unreliable queue context for each RDMA unreliable queue pair contains requestor error information and responder error information.

### BRIEF DESCRIPTIONS OF THE DRAWINGS

FIG. 1 is a block diagram depicting an exemplary computer networking system with a data center network system having a remote direct memory access (RDMA) communication network, according to an example embodiment.

FIG. 2 is a diagram depicting an exemplary RDMA system, according to an example embodiment.

FIG. 3 is an architecture diagram of an RDMA system, according to an example embodiment.

FIG. 4 is an architecture diagram of an RDMA network adapter device, according to an example embodiment.

FIG. 5 is a sequence diagram depicting a UD Send process, according to an example embodiment.

FIG. 6A is a schematic representation of a Send frame, and FIG. 6B is a schematic representation of a Write frame, according to an example embodiment.

FIGS. 7A and 7B are sequence diagrams depicting disconnection of a reliable connection between two nodes, according to an example embodiment.

### DETAILED DESCRIPTION

In the following detailed description of the embodiments of the invention, numerous specific details are set forth in order to provide a thorough understanding of the present invention. However, it will be obvious to one skilled in the art that the embodiments of the invention may be practiced without these specific details. In other instances well known methods, procedures, components, and circuits have not been described in detail so as not to unnecessarily obscure aspects of the embodiments of the invention.

The embodiments of the invention include methods, apparatuses and systems for providing remote direct memory access (RDMA).

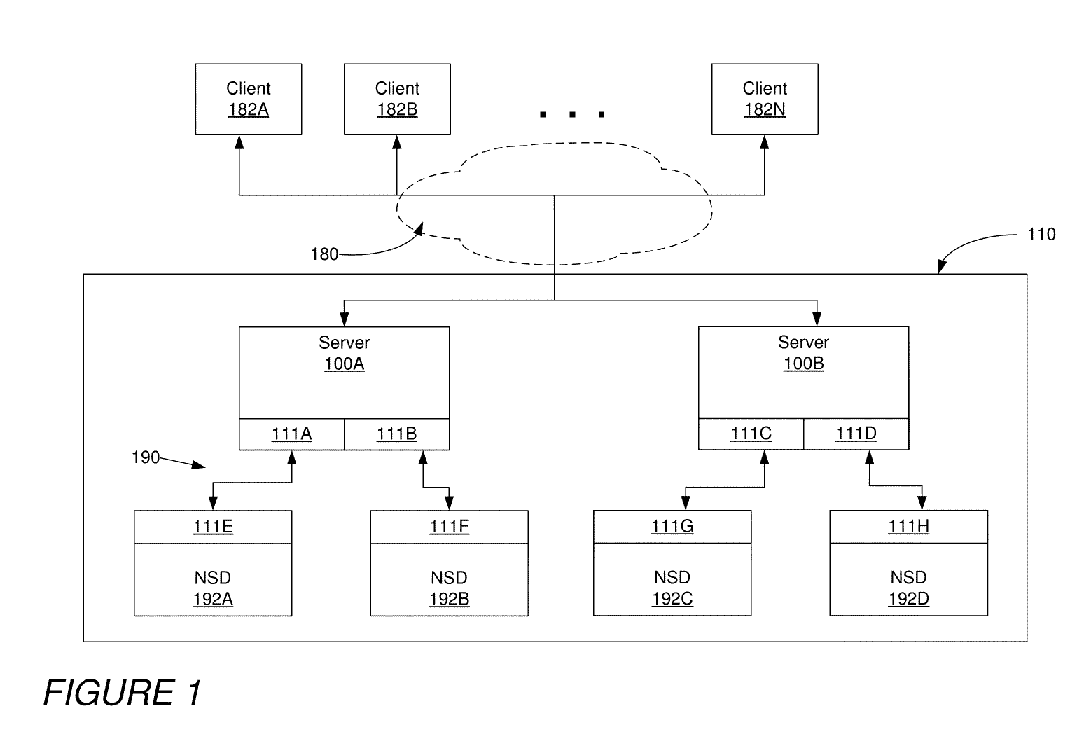

### FIG. 1

Embodiments of the invention are described beginning with a description of FIG. 1.

FIG. 1 is a block diagram that illustrates an exemplary computer networking system with a data center network system 110 having an RDMA communication network 190. One or more remote client computers 182A-182N may be coupled in communication with the one or more servers 100A-100B of the data center network system 110 by a wide area network (WAN) 180, such as the world wide web (WWW) or internet.

The data center network system 110 includes one or more server devices 100A-100B and one or more network storage devices (NSD) 192A-192D coupled in communication together by the RDMA communication network 190. RDMA message packets are communicated over wires or cables of the RDMA communication network 190 the one or more server devices 100A-100B and the one or more network storage devices (NSD) 192A-192D. To support the communication of RDMA message packets, the one or more servers 100A-100B may each include one or more RDMA network interface controllers (RNICs) 111A-111B, 111C-111D (sometimes referred to as RDMA host channel adapters), also referred to herein as network communication adapter device(s) 111.

To support the communication of RDMA message packets, each of the one or more network storage devices (NSD) 192A-192D includes at least one RDMA network interface controller (RNIC) 111E-111H, respectively. Each of the one or more network storage devices (NSD) 192A-192D includes a storage capacity of one or more storage devices (e.g., hard disk drive, solid state drive, optical drive) that can store data. The data stored in the storage devices of each of the one or more network storage devices (NSD) 192A-192D may be accessed by RDMA aware software applications, such as a database application. A client computer may optionally include an RDMA network interface controller (not shown in FIG. 1) and execute RDMA aware software applications to communicate RDMA message packets with the network storage devices 192A-192D.

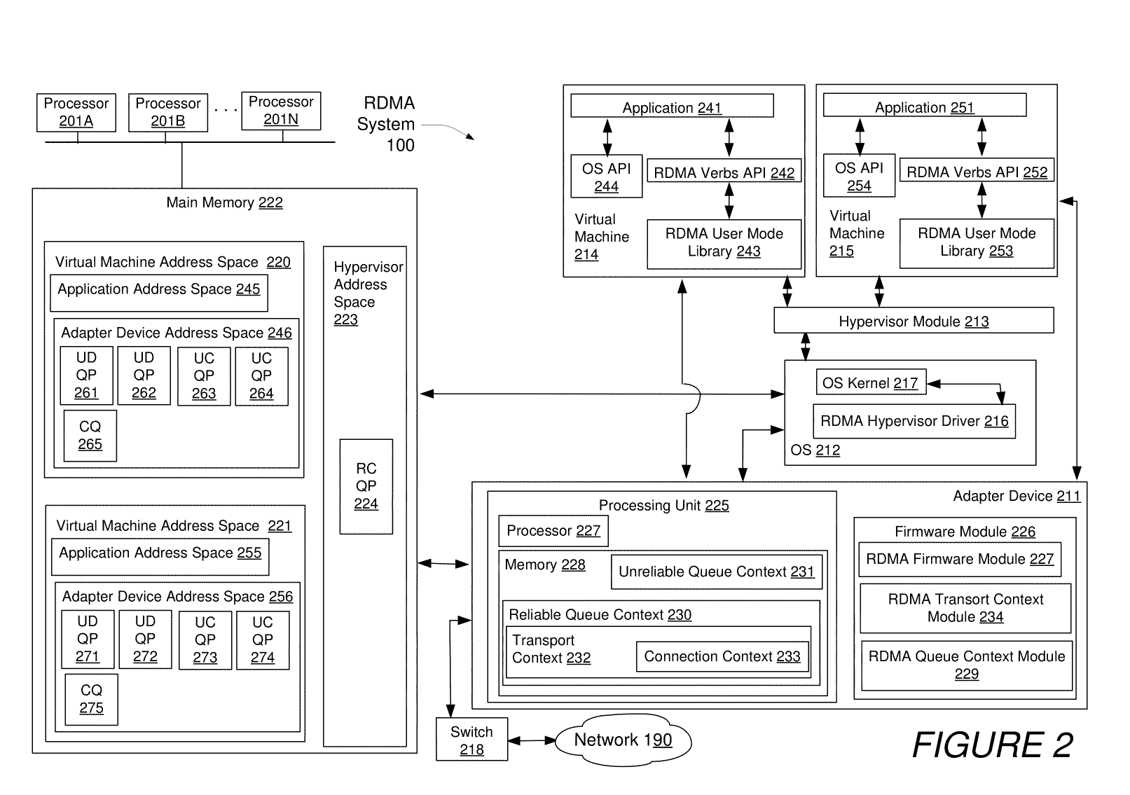

### FIG. 2

Referring now to FIG. 2, a block diagram illustrates an exemplary RDMA system 100 that can be instantiated as the server devices 100A-100B of the data center network 110, in accordance with an example embodiment. In the example embodiment, the RDMA system 100 is a server device. In some embodiments, the RDMA system 100 can be any other suitable type of RDMA system, such as, for example, a client device, a network device, a storage device, a mobile device, a smart appliance, a wearable device, a medical device, a sensor device, a vehicle, and the like.

The RDMA system 100 is an exemplary RDMA-enabled information processing apparatus that is configured for RDMA communication to transmit and/or receive RDMA message packets. The RDMA system 100 includes a plurality of processors 201A-201N, a network communication adapter device 211, and a main memory 222 coupled together.

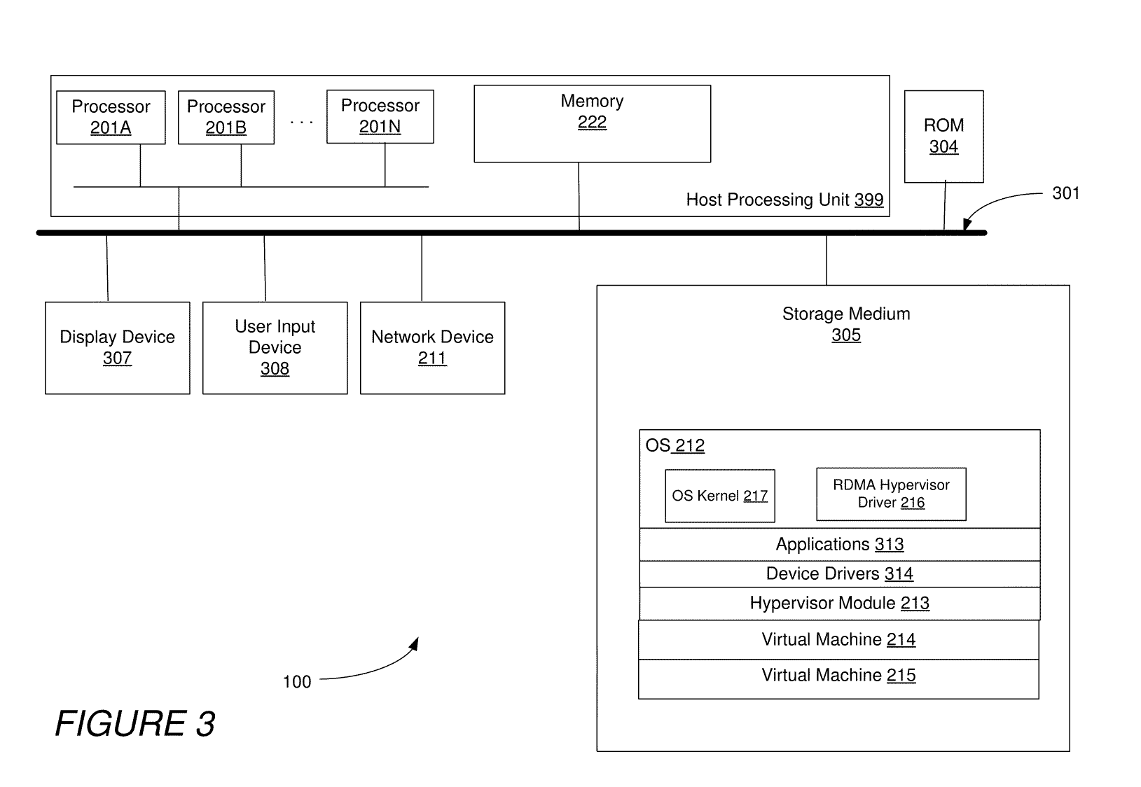

The processors 201A-201N and the main memory 222 form a host processing unit (e.g., the host processing unit 399 as shown in FIG. 3).

The adapter device 211 is communicatively coupled with a network switch 218, which communicates with other devices via the network 190.

One of the processors 201A-201N is designated a master processor to execute instructions of a host operating system (OS) 212, a hypervisor module 213, and virtual machines 214 and 215.

The host OS 212 includes an RDMA hypervisor driver 216 and an OS Kernel 217. The hypervisor module 213 uses the RDMA hypervisor driver 216 to control RDMA operations as described herein.

The virtual machine 214 includes an application 241, an RDMA Verbs API 242, an RDMA user mode library 243, and a guest OS 244. Similarly, the virtual machine 215 includes an application 251, an RDMA Verbs API 252, an RDMA user mode library 253, and a guest OS API 254.

The adapter device 211 is communicatively coupled with a network switch 218, which communicates with other devices via the network 190.

The main memory 222 includes a virtual machine address space 220 for the virtual machine 214, a virtual machine address space 221 for the virtual machine 215, and a hypervisor address space 223.

The virtual machine address space 220 includes an application address space 245, and an adapter device address space 246. The application address space 245 includes buffers used by the application 241 for RDMA transactions. The buffers include a send buffer, a write buffer, a read buffer and a receive buffer. The adapter device address space 246 includes an RDMA unreliable datagram (UD) queue pair (QP) 261, an RDMA UD QP 262, an RDMA unreliable connection (UC) QP 263, an RDMA UC QP 264, and an RDMA completion queue (CQ) 265.

Similarly, the virtual machine address space 221 includes an application address space 255, and an adapter device address space 256. The application address space 255 includes buffers used by the application 251 for RDMA transactions. The buffers include a send buffer, a write buffer, a read buffer and a receive buffer. The adapter device address space 256 includes an RDMA UD QP 271, an RDMA UD QP 272, an RDMA UC QP 273, an RDMA UC QP 274, and an RDMA CQ 275.

The hypervisor address space 223 is accessible by the hypervisor module 213 and the RDMA hypervisor driver 216, and includes an RDMA reliable connection (RC) QP 224.

The virtual machine 214 is configured for communication with the hypervisor module 213 and the adapter device 211. Similarly, the virtual machine 215 is configured for communication with the hypervisor module 213 and the adapter device 211.

The adapter device (network device) 211 includes an adapter device processing unit 225 and a firmware module 226. The adapter device processing unit 225 includes a processor 227 and a memory 228. In the example implementation, the firmware module 226 includes an RDMA firmware module 227, an RDMA transport context module 234, and an RDMA queue context module 229.

The memory 228 of the adapter device processing unit 225 includes RDMA reliable queue context 230 and RDMA unreliable queue context 231.

The RDMA reliable queue context 230 includes queue context for the RDMA RC QP 224. The RDMA reliable queue context 230 includes transport context 232. The transport context 232 includes connection context 233.

In the example embodiment, when providing a reliable connection between the adapter device 211 and a different adapter device (e.g., a remote adapter device of a remote RDMA system or a different adapter device of the RDMA system 100), the adapter device processing unit 225 uses one RDMA RC QP of the adapter device 211 for reliable communication with an RDMA RC QP of the different adapter device, and stores RDMA reliable queue context for the one RDMA RC QP of the adapter device 211 (e.g., the RDMA RC QP 224). In some implementations, the RDMA reliable queue context for the one RDMA RC QP (e.g., the reliable queue context 230) includes transport context (e.g., the transport context 232) for all unreliable RDMA traffic between RDMA unreliable queue pairs (e.g., UD or UC queue pairs) of the adapter device 211 and RDMA unreliable queue pairs of the different adapter device, and the transport context includes connection context (e.g., the connection context 233) for the reliable connection provided by the one RDMA RC QP. In this manner, the reliable connection provided by the one RDMA RC QP (e.g., the RDMA RC QP 224) provides a tunnel for tunneling unreliable RDMA traffic between one or more RDMA unreliable queue pairs (e.g., UD or UC queue pairs) of the adapter device 211 and one or more RDMA unreliable queue pairs of the different adapter device.

In the example implementation, the RDMA firmware module 227 includes instructions that when executed by the adapter device processing unit 225 cause the adapter device 211 to initiate a reliable connection between the adapter device 211 and a different adapter device, and tunnel packets of one or more RDMA unreliable queue pairs (e.g., the RDMA UD QP 261, the RDMA UD QP 262, the RDMA UC QP 263, the RDMA UC QP 264, the RDMA UD QP 271, the RDMA UD QP 272, the RDMA UC QP 273, and the RDMA UC QP 274) through the reliable connection (provided by the RDMA RC QP (e.g., the RDMA RC QP 224)) by using the RDMA reliable queue context 230 and the RDMA unreliable queue context 231.

Similarly, in the example implementation, the RDMA hypervisor driver 216 includes instructions that when executed by the host processing unit 399 cause the hypervisor module 213 to initiate a reliable connection between the adapter device 211 and a different adapter device, and tunnel packets of one or more RDMA unreliable queue pairs (e.g., the RDMA UD QP 261, the RDMA UD QP 262, the RDMA UC QP 263, the RDMA UC QP 264, the RDMA UD QP 271, the RDMA UD QP 272, the RDMA UC QP 273, and the RDMA UC QP 274) through the reliable connection (provided by the RDMA RC QP (e.g., the RDMA RC QP 224)) by using the RDMA reliable queue context 230 and the RDMA unreliable queue context 231.

The RDMA transport context module 234 is constructed to manage the RDMA reliable queue context 230, and the RDMA queue context module 229 is constructed to manage the RDMA unreliable queue context 231. In the example implementation, the adapter device processing unit 225 uses the RDMA transport context module 234 to access the RDMA reliable queue context 230 and uses the RDMA queue context module 229 to access the unreliable queue context 231 during tunneling of packets through the reliable connection provided by the RDMA RC QP (e.g., the RDMA RC QP 224).

Each tunneled RDMA unreliable queue pair packet includes a tunnel header that includes an adapter device opcode that indicates that the packet is tunneled through the reliable connection, and includes information for the reliable connection. In the example implementation, the tunnel header includes a queue pair identifier of the RDMA RC QP of the different adapter device that is in communication with the RDMA RC QP of the adapter device 211 (e.g., the RDMA RC QP 224).

The RDMA unreliable queue context 231 includes queue context for the RDMA UD QP 261, the RDMA UD QP 262, the RDMA UC QP 263, the RDMA UC QP 264, the RDMA CQ 265, the RDMA UD QP 271, the RDMA UD QP 272, the RDMA UC QP 273, the RDMA UC QP 274, and the RDMA CQ 275.

In the example implementation, the RDMA unreliable queue context (e.g., the context 231) for each RDMA unreliable queue pair contains an identifier that links to the RDMA reliable queue pair context 230 corresponding to the reliable connection used to tunnel the unreliable queue pair traffic. In the example implementation, the linked reliable queue pair context includes a connection state of the reliable connection, and a tunnel identifier (e.g., a QP ID of the corresponding RC QP 224) that identifies the reliable connection. In the example implementation, the RDMA reliable queue pair context corresponding to an RDMA UC queue pair includes connection parameters for an unreliable connection of the RDMA UC queue pair, whereas the RDMA reliable queue pair context corresponding to an RDMA UD queue pair includes a destination address handle of the RDMA UD queue pair. In the example implementation, the RDMA unreliable queue context for each RDMA unreliable queue pair contains a send queue index, a receive queue index, RDMA protection domain information, queue key information, event queue element generation information. In the example implementation, the RDMA unreliable queue context for each RDMA unreliable queue pair contains requestor error information and responder error information.

In the example implementation, the RDMA Verbs API 242, the RDMA user mode library 243, the RDMA Verbs API 252, the RDMA user mode library 253, the RDMA hypervisor driver 216, and the adapter device firmware module 226 provide RDMA functionality in accordance with the INIFNIBAND Architecture (IBA) specification (e.g., INIFNIBAND Architecture Specification Volume 1, Release 1.2.1 and Supplement to INIFNIBAND Architecture Specification Volume 1, Release 1.2.1—RoCE Annex A16, and Annex A17 RoCEv2 specification, which are incorporated by reference herein).

The RDMA verbs API 242 and 252 implement RDMA verbs, the interface to an RDMA enabled network interface controller. The RDMA verbs can be used by user-space applications to invoke RDMA functionality. The RDMA verbs typically provide access to RDMA queuing and memory management resources, as well as underlying network layers.

Although the example implementation shows a user mode consumer, in some implementations similar functionality of tunneling unreliable RDMA through a reliable channel is achieved by a kernel mode consumer in the guest OS.

In some embodiments, a non-virtualized host implements a similar tunneling mechanism for the unreliable QPs.

In some implementations, a similar tunneling technique is used for VMs (Virtual Machines) on the same node.

In some implementations, containers based virtualization is used, and similar tunneling techniques are used to provide a reliable QP tunnel for the UD/UC QPs in the containers.

In the example implementation, the RDMA verbs provided by the RDMA Verbs API 242 and 252 are RDMA verbs that are defined in the INIFNIBAND Architecture (IBA) specification.

The hypervisor module 213 abstracts the underlying hardware of the RDMA system 100 with respect to virtual machines hosted by the hypervisor module (e.g., the virtual machines 214 and 215), and provides a guest operating system of each virtual machine (e.g., the guest OSs 244 and 254) with access to a processor and the adapter device 211 of the RDMA system 100. The hypervisor module 213 is communicatively coupled with the adapter device 211 (via the host OS 212). The hypervisor module 213 is constructed to provide network communication for each guest OS (e.g., the guest OSs 244 and 254) via the adapter device 211. In some implementations, the hypervisor module 213 is an open source hypervisor module.

### FIG. 3

FIG. 3 is an architecture diagram of the RDMA system 100 in accordance with an example embodiment. In the example embodiment, the RDMA system 100 is a server device.

The bus 301 interfaces with the processors 201A-201N, the main memory (e.g., a random access memory (RAM)) 222, a read only memory (ROM) 304, a processor-readable storage medium 305, a display device 307, a user input device 308, and the network device 211 of FIG. 2.

The processors 201A-201N may take many forms, such as ARM processors, X86 processors, and the like.

In some implementations, the RDMA system 100 includes at least one of a central processing unit (processor) and a multi-processor unit (MPU).

As described above, the processors 201A-201N and the main memory 222 form a host processing unit 399. In some embodiments, the host processing unit includes one or more processors communicatively coupled to one or more of a RAM, ROM, and machine-readable storage medium; the one or more processors of the host processing unit receive instructions stored by the one or more of a RAM, ROM, and machine-readable storage medium via a bus; and the one or more processors execute the received instructions. In some embodiments, the host processing unit is an ASIC (Application-Specific Integrated Circuit). In some embodiments, the host processing unit is a SoC (System-on-Chip). In some embodiments, the host processing unit includes one or more of the RDMA hypervisor driver, the virtual machines, and the queue pairs of the adapter device address space, and the RC queue pair of the hypervisor address space.

The network adapter device 211 provides one or more wired or wireless interfaces for exchanging data and commands between the RDMA system 100 and other devices, such as a remote RDMA system. Such wired and wireless interfaces include, for example, a universal serial bus (USB) interface, Bluetooth interface, Wi-Fi interface, Ethernet interface, near field communication (NFC) interface, and the like.

Machine-executable instructions in software programs (such as an operating system, application programs, and device drivers) are loaded into the memory 222 (of the host processing unit 399) from the processor-readable storage medium 305, the ROM 304 or any other storage location. During execution of these software programs, the respective machine-executable instructions are accessed by at least one of processors 201A-201N (of the host processing unit 399) via the bus 301, and then executed by at least one of processors 201A-201N. Data used by the software programs are also stored in the memory 222, and such data is accessed by at least one of processors 201A-201N during execution of the machine-executable instructions of the software programs.

The processor-readable storage medium 305 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 305 includes software programs 313, device drivers 314, and the host operating system 212, the hypervisor module 213, and the virtual machines 214 and 215 of FIG. 2. As described above, the host OS 212 includes the RDMA hypervisor driver 216 and the OS Kernel 217.

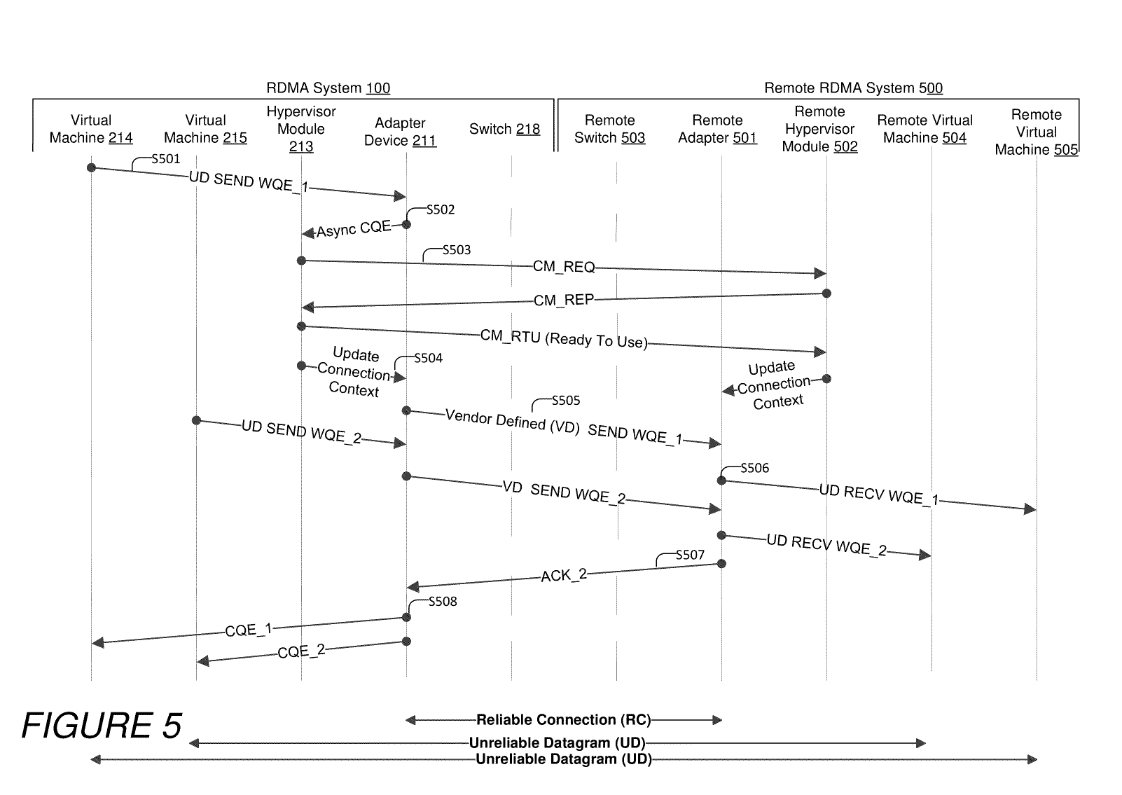

In some embodiments, the RDMA hypervisor driver 216 includes instructions that are executed by the host processing unit 399 to perform the processes described below with respect to FIGS. 5 to 7. More specifically, in such embodiments, the RDMA hypervisor driver 216 includes instructions to control the host processing unit 399 to tunnel packets of RDMA unreliable queue pairs (e.g., UD or UC queue pairs) through a reliable connection provided by an RC queue pair.

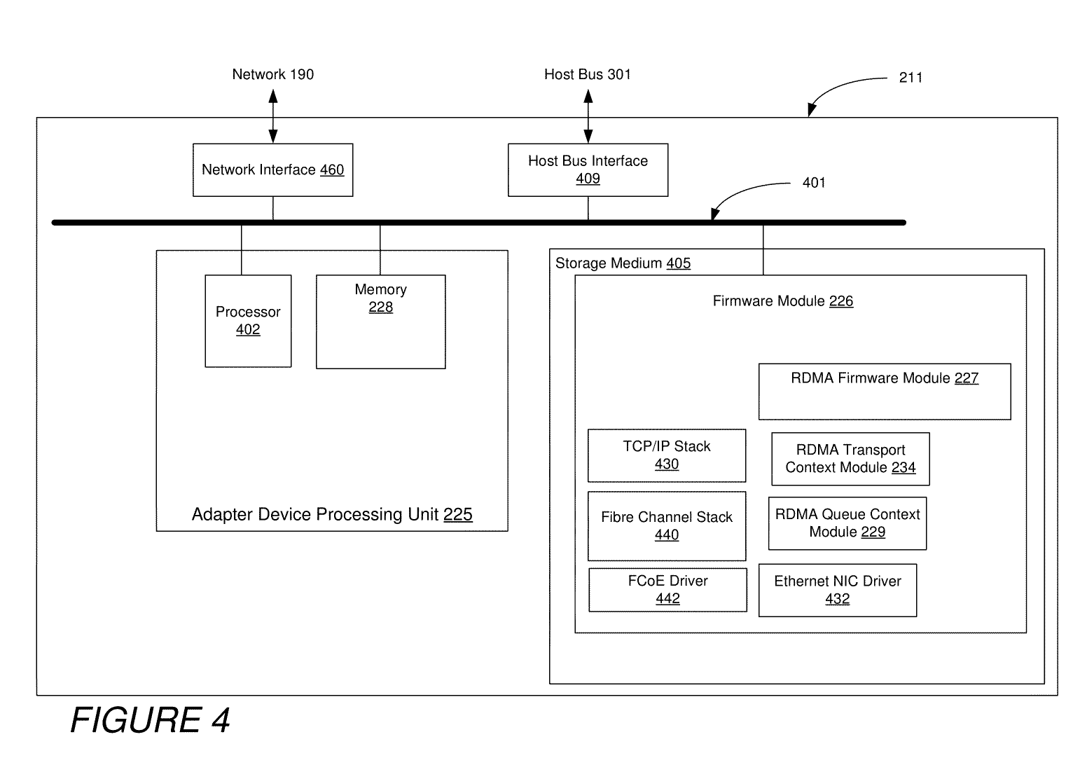

### FIG. 4

An architecture diagram of the RDMA network adapter device 211 of the RDMA system 100 is provided in FIG. 4.

In the example embodiment, the RDMA network adapter device 211 is a network communication adapter device that is constructed to be included in a server device. In some embodiments, the RDMA network device is a network communication adapter device that is constructed to be included in one or more of different types of RDMA systems, such as, for example, client devices, network devices, mobile devices, smart appliances, wearable devices, medical devices, storage devices, sensor devices, vehicles, and the like.

The bus 401 interfaces with a processor 402, a random access memory (RAM) 228, a processor-readable storage medium 405, a host bus interface 409 and a network interface 460.

The processor 402 may take many forms, such as, for example, a central processing unit (processor), a multi-processor unit (MPU), an ARM processor, and the like.

The processor 402 and the memory 228 form the adapter device processing unit 225. In some embodiments, the adapter device processing unit includes one or more processors communicatively coupled to one or more of a RAM, ROM, and machine-readable storage medium; the one or more processors of the adapter device processing unit receive instructions stored by the one or more of a RAM, ROM, and machine-readable storage medium via a bus; and the one or more processors execute the received instructions. In some embodiments, the adapter device processing unit is an ASIC (Application-Specific Integrated Circuit). In some embodiments, the adapter device processing unit is a SoC (System-on-Chip). In some embodiments, the adapter device processing unit includes the firmware module 226. In some embodiments, the adapter device processing unit includes the RDMA firmware module 227. In some embodiments, the adapter device processing unit includes the RDMA transport context module 234. In some embodiments, the adapter device processing unit includes the RDMA queue context module 229.

The network interface 460 provides one or more wired or wireless interfaces for exchanging data and commands between the network communication adapter device 211 and other devices, such as, for example, another network communication adapter device. Such wired and wireless interfaces include, for example, a Universal Serial Bus (USB) interface, Bluetooth interface, Wi-Fi interface, Ethernet interface, Near Field Communication (NFC) interface, and the like.

The host bus interface 409 provides one or more wired or wireless interfaces for exchanging data and commands via the host bus 301 of the RDMA system 100. In the example implementation, the host bus interface 409 is a PCIe host bus interface.

Machine-executable instructions in software programs are loaded into the memory 228 (of the adapter device processing unit 225) from the processor-readable storage medium 405, or any other storage location. During execution of these software programs, the respective machine-executable instructions are accessed by the processor 402 (of the adapter device processing unit 225) via the bus 401, and then executed by the processor 402. Data used by the software programs are also stored in the memory 228, and such data is accessed by the processor 402 during execution of the machine-executable instructions of the software programs.

The processor-readable storage medium 405 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 405 includes the firmware module 226.

The firmware module 226 includes instructions to perform the processes described below with respect to FIGS. 5 to 7.

More specifically, the firmware module 226 includes the RDMA firmware module 227, the RDMA transport context module 234, and the RDMA queue context module 229, a TCP/IP stack 430, an Ethernet NIC driver 432, a Fibre Channel stack 440, and an FCoE (Fibre Channel over Ethernet) driver 442.

RDMA verbs are implemented in the RDMA firmware module 227. In the example implementation, the RDMA firmware module 227 includes an INFINIBAND protocol stack. In the example implementation the RDMA firmware module 227 handles different protocol layers, such as the transport, network, data link and physical layers.

In some embodiments, the RDMA network device 211 is configured with full RDMA offload capability. The RDMA network device 211 uses the Ethernet NIC driver 432 and the corresponding TCP/IP stack 430 to provide Ethernet and TCP/IP functionality. The RDMA network device 211 uses the Fibre Channel over Ethernet (FCoE) driver 442 and the corresponding Fibre Channel stack 440 to provide Fibre Channel over Ethernet functionality.

In the example implementation, the memory 228 includes the RDMA reliable queue context 230 and the RDMA unreliable queue context 231.

### FIG. 5

FIG. 5 is a sequence diagram depicting an RDMA unreliable datagram (UD) Send process, according to an example embodiment.

In the process of FIG. 5, according to the example implementation, the host processing unit 399 executes instructions of the RDMA hypervisor driver 216 to create a reliable connection between the adapter device 211 and a different adapter device (e.g, adapter device 501 of remote RDMA system 500), and the adapter device processing unit 225 executes instructions of the RDMA firmware module 227 to tunnel UD Send packets of one or more RDMA UD queue pairs (e.g., the RDMA UD QP 261, the RDMA UD QP 262, the RDMA UD QP 271, and the RDMA UD QP 272) through the reliable connection (provided by the RDMA RC QP (e.g., the RDMA RC QP 224) by using the RDMA reliable queue context 230 and the RDMA unreliable queue context 231.

In some embodiments, the adapter device processing unit 225 executes instructions of the RDMA firmware module 227 to initiate a reliable connection between the adapter device 211 and a different adapter device. In some embodiments, the host processing unit 399 executes instructions of the RDMA hypervisor driver 216 to tunnel UD Send packets of one or more RDMA UD queue pairs through the reliable connection by using the RDMA reliable queue context 230 and the RDMA unreliable queue context 231.

In FIG. 5, the remote RDMA system 500 is similar to the RDMA system 100. More specifically, the hypervisor module 502, the adapter device 501, and an RDMA hypervisor driver of the remote RDMA system 500 are similar to the respective hypervisor module 213, adapter device 211 and RDMA hypervisor driver 216 of the RDMA system 100. The adapter device 501 communicates with the RDMA system 100 via the remote switch 503 and the switch 218. The remote system 500 includes remote virtual machines 504 and 505. The hypervisor module 502 communicates with the remote virtual machines 504 and 505. The hypervisor module 213 uses the RDMA hypervisor driver 216 (of FIGS. 2 and 3) to control RDMA operations as described herein. Similarly, the hypervisor module 502 uses the RDMA hypervisor driver of the remote RDMA system 500 to control RDMA operations as described herein.

At process 5501, the virtual machine 214 generates a first RDMA UD Send Work Queue Element (WQE) and provides the UD Send WQE to the adapter device 211. In some implementations, the virtual machine provides the UD Send WQE to the hypervisor module 213.

In the example implementation, the UD Send WQE is associated with a UD address vector which is used by the adapter device 211 to associate the WQE to a cached RC connection on the adapter device 211.

At the process 5502, the adapter device 211 determines whether an RC tunnel has been created between the RDMA system 100 and the remote RDMA system 500. In the example implementation, the adapter device 211 determines whether the RC tunnel (RC connection) has been created by determining whether the connection context 233 associated with the UD address vector of the UD Send WQE contains a valid tunnel identifier for the RC tunnel.

At the process 5502, the adapter device 211 determines that an RC tunnel has not been created between the RDMA system 100 and the remote RDMA system 500, and the adapter device 211 generates an asynchronous (async) completion queue element (CQE) to initiate connection establishment by the hypervisor module 213, and provides the CQE to the hypervisor module 213. The adapter device 211 passes the UD address vector of the UD Send WQE along with the async CQE.

In some implementations, the adapter device provides the CQE to the virtual machine 214 (or the host OS 212), and the virtual machine 214 (or the host OS 212) creates the RC tunnel in a process similar to the process performed by the hypervisor module 213, as described herein.

At process S503, the hypervisor module 213 leverages the existing connection management stack to establish the RC connection between the RDMA system 100 and the remote RDMA system 500 via the RDMA RC QP of the RDMA system 100 (e.g., the RDMA RC QP 224). The hypervisor module 502 of the remote system 500 establishes the connection with the RC QP 224. As shown in FIG. 5, in the example implementation the hypervisor module 213 initiates connection establishment by sending an INFINIBAND “CM_REQ” (Request for Communication) message to the remote hypervisor module 502, and the hypervisor module 502 responds by sending an INFINIBAND “CM_REP” (Reply to Request for Communication) message to the hypervisor module 213. Responsive to the “CM-REP” message, the hypervisor module 213 sends the remote hypervisor module 502 an INFINIBAND “CM_RTU” (Ready To Use) message.

While the RC connection is being established, UD QPs referencing the same UD address vector (e.g., transmitting to the same remote RDMA system 500) stall waiting on the connection establishment. Similarly, while the RC connection is being established, UC QPs referencing the same connection parameters in the case of a UC QP (e.g., transmitting to the same remote RDMA system 500) stall waiting on the connection establishment. The associated connection context (e.g., of the connection context 233) for UD and UC QPs waiting for establishment of the RC connection indicate an invalid tunnel identifier. The UD and UC QPs waiting for establishment of the RC connection are rescheduled by a transmit scheduler of the adapter device 211 (not shown in the Figures). In the example embodiment, the transmit scheduler performs scheduling and rescheduling according to a QoS (Quality of Service) policy. In the example embodiment, the QoS policy is a round-robin policy in which UD QPs or UC QPs associated with the same RC connection (e.g., the same RC QP) are scheduled round-robin.

In the example implementation, for a UD or UC QP selected by the transmit scheduler, the number of work requests (WRs) transmitted for the selected UD or UC QP depends on the QoS policy used by the transmit scheduler for the QP or a for QP group of which the QP is a member.

At process S504, the hypervisor module 213 updates the connection context 233 corresponding to the RC connection between the RDMA system 100 and the remote RDMA system 500 (e.g., the connection context for the RDMA RC QP 224), and the hypervisor module 502 updates the connection context for the corresponding RDMA RC QP of the remote RDMA system 500. At process S504, the RC connection is established between the RDMA system 100 and the remote RDMA system 500, and the unreliable queue context 231 and the corresponding reliable connection queue context 230 of all the associated unreliable QP's (e.g., UC and UD QPs) are updated to reflect the association with the RC tunnel by indicating a valid tunnel identifier. Upon subsequent scheduling of stalled UD and UC QPs that had been waiting for establishment of the RC connection, the WQEs of these QP's are processed since the QPs are associated with a valid tunnel identifier (as indicated by the associated connection context 233).

In the example implementation, the hypervisor module 213 updates the unreliable queue context 231 and the corresponding reliable connection queue context 230. In some embodiments, the adapter device 211 updates the unreliable queue context 231 and the corresponding reliable connection queue context 230. In some embodiments, the adapter device 211 updates the unreliable queue context 231 by using the RDMA queue context module 229, and updates the corresponding reliable connection queue context 230 by using the RDMA transport context module 234.

At process S505, the adapter device 211 performs tunneling by encapsulating the UD Send frame (e.g,. an unreliable QP Ethernet frame) within an RC Send frame (e.g., a reliable QP Ethernet frame). In some embodiments, the hypervisor module 213 performs the tunneling by encapsulating the UD Send frame (e.g., in an embodiment in which the RDMA system 100 is a Para-virtualized system).

In the example implementation, the adapter device 211 performs encapsulation by adding a tunnel header to the UD Send frame. In the example implementation, the tunnel header includes an adapter device opcode that is provided by a vendor of the adapter device 211. The adapter device opcode indicates that the frame (or packet) is tunneled through a reliable connection. The tunnel header includes information for the reliable connection. In the example implementation, the tunnel header includes a QP identifier (ID) of the RDMA RC QP of the remote RDMA system 500 that forms the RC connection with the RDMA RC QP 224. In the example implementation, the tunnel header is added before an RDMA Base Transport Header (BTH) of the UD Send frame to encapsulate the UD Send frame in an RC Send frame. In the example embodiment, the tunnel header is an RDMA BTH of an RC Send frame of the RDMA RC QP 224, and the Destination QP of the RDMA BTH header indicates the RC QP of the remote RDMA system 500, and the opcode of the RDMA BTH header is the vender defined opcode that is defined by a vendor of the adapter device 211.

The adapter device 211 updates the PSN in the tunnel header (e.g,. the RC BTH).

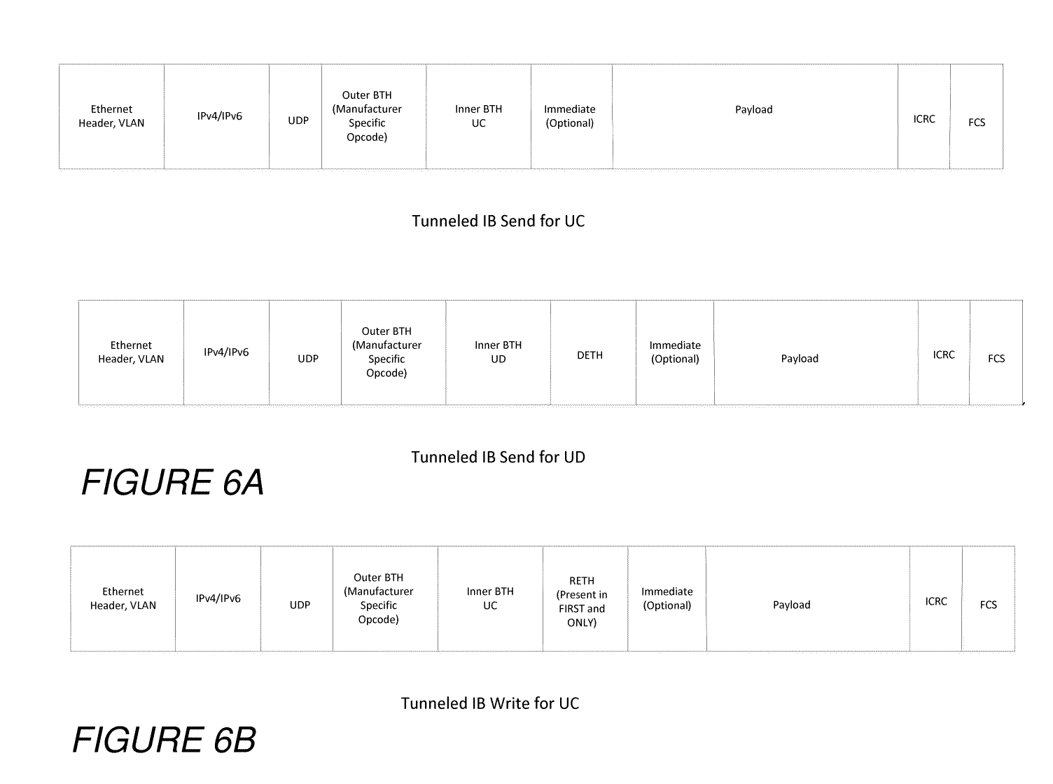

FIG. 6A is a schematic representation of an encapsulated Send frame of an unreliable QP Ethernet frame. In the case of an encapsulated UD Send frame, the “inner BTH” (e.g., the BTH of the UD Send frame) is a UD BTH that is followed by an RDMA DETH header. The “outer BTH” (e.g,. the BTH of the RC Send frame) precedes the “inner BTH” and includes an adapter device opcode (e.g., “manufacturer specific opcode”). In this manner, the format of the encapsulated wire frame (or packet) is the same as that for an RC Send frame (or packet).

Returning to FIG. 5, at the process S505, during encapsulation, the adapter device 211 performs ICRC computation in accordance with ICRC processing for an RC packet. As shown in FIG. 5 (process S505), the “VD Send WQE_1” (and the “VD Send WQE_2) is a UD Send WQE that specifies the vendor defined (VD) opcode.

At process S506, the adapter device 501 of the remote RDMA system 500 receives the encapsulated UD Send packet (e.g., “VD Send WQE_1”) at the remote RC QP of the adapter device 501 that is in communication with the RC QP 224. The adapter device processing unit of the adapter device 501 executes instructions of the RDMA firmware module of the adapter device 501 to use the remote RC QP to perform transport level processing of the received encapsulated packet. If FCS (Frame Check Sequence) and iCRC checks pass (e.g., the PSN, Destination QP state, etc. are validated), then the adapter device 501 determines whether the encapsulated packet includes a tunnel header. In the example embodiment, the adapter device 501 determines whether the encapsulated packet includes a tunnel header by determining whether a first-identified BTH header (e.g., the “outer BTH header”) includes the adapter device opcode. If the adapter device 501 determines that the outer BTH header includes the adapter device opcode, then the adapter device 501 determines that the encapsulated packet includes a tunnel header, namely, the outer BTH header. The outer BTH is then subjected to transport checks (e.g. PSN, Destination QP state) according to RC transport level checks.

The adapter device 501 removes the tunnel header and the adapter device 501 uses the inner BTH header for further processing. The inner BTH provides the destination UD QP. The adapter device 501 fetches the associated UD QP unreliable queue context of the adapter device processing unit of the adapter device 501, and retrieves the corresponding buffer information.

At process S506 the data of the UD Send packet are placed successfully. As shown in FIG. 5, the adapter device 501 generates a UD Receive WQE (“UD RECV WQE_1”) from the information provided in the encapsulated UD Send packet (e.g., “VD Send WQE_1”), the adapter device 501 provides the UD Receive WQE to the remote virtual machine 505, and the UD Receive WQE is successfully processed at the remote RDMA system 500.

At the process S507, responsive to successful placement of the UD Send packet, adapter device 501 schedules an RC ACK to be sent. Responsive to reception of an RC ACK for a previously transmitted packet, the adapter device 211 looks up the associated outstanding WR journals (of the corresponding RC QP, e.g., the RC QP 224) to retrieve the corresponding UD QP identifier (or UC QP identifier in the case of a UC Send process or a UC Write process as described herein).

At process S508, the adapter device 211 generates CQEs for the UD QPs (or UC QPs in the case of a UC Send process or a UC Write process as described herein) and provides the CQE's to the hypervisor module 213. In the example implementation, the adapter device 211 generates and provides CQEs depending on a configured interrupt policy.

Thus, in the transmit path, unreliable QP CQEs (e.g., UD QP CQEs and UC QP CQEs) are generated when the peer (e.g,. the remote RDMA system 500) acknowledges the associated RC packet.

At the adapter device 501, in a case where the UD QP of the adapter device 501 indicates lack of a RQE (Receive Queue Element), the adapter device 501 schedules an RNR ACK (Receiver Not Ready Acknowledge) to be sent on the associated RC connection. In a case where the adapter device 501 encounters an invalid request, a remote access error, or a remote operation error, then the adapter device 501 passes an appropriate NAK (Negative Acknowledge) code to the RC connection (RC tunnel). The RC tunnel (connection) generates the NAK packet to the RDMA system 100 to inform the system 100 of the error encountered at the remote RDMA system 500.

In the example implementation, for a UD (or UC) QP selected by the transmit scheduler, the number of work requests (WRs) transmitted for the selected UD (or UC) QP depends on the QoS policy used by the transmit scheduler for the QP (or a QP group of which the QP is a member). For each WR transmitted via the RC QP 224, the RC QP 224 stores outstanding WR information in an associated RC QP (RC tunnel) journal of the transport context 232. The outstanding WR information for each WR contains, among other things, an identifier of the unreliable QP (e.g., UD QP and UC QP) corresponding to the outstanding WR, PSN (packet sequence number) information, timer information, bytes transmitted, a queue index, and signaling information.

The RC tunnel (connection) provided by the RC QP 224 is constructed to send multiple outstanding WRs from different unreliable QPs (e.g,. UD and UC QPs) while waiting for an ACK to arrive from the adapter device 501.

For example, as shown in FIG. 5, the RC tunnel provided by the RC QP 224 sends a WR from a UD QP of the virtual machine 214 that provides the WQE labeled “UD SEND WQE_1”, and a WR from a UD QP of the virtual machine 215 that provides the WQE labeled “UD SEND WQE_2”, and the RC QP 224 receives a single ACK from the adapter device 501 responsive to the “UD SEND WQE_1” and the “UD SEND WQE_2”. Responsive to the single ACK from the adapter device 501, the adapter device 211 sends a CQE labeled “CQE_1” to the virtual machine 214, and a CQE labeled “CQE_2” to the virtual machine 215.

In a case where an RNR NAK (Receiver Not Ready Negative Acknowledge) is received by the adapter device 211 from the adapter device 501, the adapter device retrieves the corresponding WR from the outstanding WR journal, flushes subsequent journal entries, and adds the RC QP (e.g., the RC QP 224) to the RNR (Receiver Not Ready) timer list. Upon expiration of the RNR timer, the WR that generated the RNR is retransmitted.

In a case where the adapter device 211 receives a NAK (Negative Acknowledge) sequence error from the adapter device 501, the RC QP (e.g., the RC QP 224) retransmits the corresponding WR by retrieving the outstanding WR journal. The subsequent journal entries are flushed and retransmitted.

In a case where the adapter device 211 receives one of a) NAK (Negative Acknowledge) invalid request, b) NAK remote access error, or c) NAK remote operation error from the adapter device 501, the adapter device 211 retrieves the associated unreliable QP (e.g., UD QP, UC QP) from the WR journal list and tears down the unreliable QP. The subsequent journal entries are flushed and retransmitted. The reliable connection provided by the RC QP (e.g., the RC QP 224) continues to work with other unreliable QPs that use the reliable connection.

In a case where the RC QP (e.g., the RC QP 224) of the reliable connection detects timeouts after subsequent retries, the adapter device 211: sets the corresponding reliable connection state (e.g., in the connection state of the transport context 232) to an error state; tears down the reliable connection provided by the RC QP; and tears down any associated unreliable QPs.

### RDMA Unreliable Connection (UC) Send

An RDMA unreliable connection (UC) Send process is similar to the RDMA UD Send process.

In a UC Send process, the RC connection is created first, and then send queue (SQ) Work Queue Elements (WQEs) from multiple UC connections are tunneled through the single RC connection.

For example, a WQE from a UC connection of the virtual machine 214 and a WQE from a UC connection of the virtual machine 215 are both sent via an RC connection provided by the RC QP 224.

As with UD Send packets (or frames), UC Send packets are encapsulated inside an RC packet for the created RC connection.

FIG. 6A is a schematic representation of an encapsulated Send frame of an unreliable QP Ethernet frame. In the case of an encapsulated UC Send frame, the “inner BTH” (e.g., the BTH of the UC Send frame) is a UC BTH followed by the payload. The “outer BTH” (e.g,. the BTH of the RC Send frame) precedes the “inner BTH” and includes an adapter device opcode (e.g., “manufacturer specific opcode”). In this manner, the format of the encapsulated wire frame (or packet) is the same as that for an RC Send frame (or packet).

### RDMA UC Write

An RDMA UC Write process is similar to the RDMA UD Send process.

In a UC Write process, the RC connection is created first, and then send queue (SQ) Work Queue Elements (WQEs) from multiple UC connections are tunneled through the single RC connection. For example, a WQE from a UC connection of the virtual machine 214 and a WQE from a UC connection of the virtual machine 215 are both sent via an RC connection provided by the RC QP 224.

As with UD Send packets (or frames), UC Write packets are encapsulated inside an RC packet for the created RC connection.

FIG. 6B is a schematic representation of an encapsulated UC Write frame. The “inner BTH” (e.g., the BTH of the UC Write frame) is a UC BTH followed by an RDMA RETH header. The “outer BTH” (e.g,. the BTH of the RC Write frame) precedes the “inner BTH” and includes an adapter device opcode (e.g., “manufacturer specific opcode”). In this manner, the format of the encapsulated wire frame (or packet) is the same as that for an RC Write frame (or packet).

During reception of a UC Write by the remote RDMA system 500, the adapter device 501 of the remote RDMA system 500 receives the encapsulated UC Write packet at the remote RC QP of the adapter device 501 that is in communication with the RC QP 224. The adapter device processing unit of the adapter device 501 executes instructions of the RDMA firmware module of the adapter device 501 to use the remote RC QP to perform transport level processing of the received encapsulated packet. If FCS (Frame Check Sequence) and iCRC checks pass (e.g., the PSN, Destination QP state, etc. are validated), then the adapter device 501 determines whether the encapsulated packet includes a tunnel header. In the example embodiment, the adapter device 501 determines whether the encapsulated packet includes a tunnel header by determining whether a first-identified BTH header (e.g., the “outer BTH header”) includes the adapter device opcode. If the adapter device 501 determines that the outer BTH header includes the adapter device opcode, then the adapter device 501 determines that the encapsulated includes a tunnel header, namely, the outer BTH header. The outer BTH is then subjected to transport checks (e.g. PSN, Destination QP state) according to RC transport level checks.

The adapter device 501 removes the tunnel header and the adapter device 501 uses the inner BTH header for further processing. The inner BTH provides the destination UC QP. The adapter device 501 fetches the associated UC QP unreliable queue context and RDMA memory region context (of the adapter device processing unit of the adapter device 501), and retrieves the corresponding buffer information. If the data of the UC Write packet is placed successfully, then the adapter device 501 schedules an RC ACK that results in generation of the associated CQE for the UC Write. In other words, in the transmit path, UC CQEs are generated when the peer (e.g,. the remote RDMA system 500) acknowledges the associated RC packet.

If the adapter device 501 encounters an invalid request, a remote access error, or a remote operation error, then the adapter device 501 passes an appropriate NAK code to the RC connection (RC tunnel). The RC tunnel (connection) generates the NAK packet to the RDMA system 100 to inform the system 100 of the error encountered at the remote RDMA system 500.

### Reliable Queue Context and Unreliable Queue Context

Division of queue context between reliable queue context (e.g., of the RC QP for the RC connection) and unreliable queue context (e.g, of a UD or UC QP) is shown below in Table 1.

TABLE 1

| | Common Transport | |
|---|---|---|
| | context | Per Queue context |
| | (RC context) | (SQ/RQ context) |
| SQ,RQ Queue index | N | Y |
| Protection domain | N | Y |
| Connection state | Y | N |
| Transport check | Y | N |
| Bandwidth reservation, ETS | Y | N |
| Congestion management | Y | N |
| QCN/CNP | | |
| Flow control, PFC | Y | N |
| Journals, Retransmit | Y | N |
| Timers management | Y | N |
| CQE/EQE generation | N | Y |
| Transport error, timeout | Y | N |
| Tear down entire connection | | |
| Flush all mapped queues | | |
| Requester, Responder error | N | Y |
| Tear down individual queue | | |
| Flush individual queue | | |

The per queue context (e.g., the unreliable queue context 231) manages the UD/UC queue related information (e.g., Q_Key, Protection Domain (PD), Producer index, Consumer index, Interrupt moderation, QP state, etc.) for the RDMA unreliable queue pairs (e.g., the RDMA UD QP 261, the RDMA UD QP 262, the RDMA UC QP 263, the RDMA UC QP 264, the RDMA UD QP 271, the RDMA UD QP 272, the RDMA UC QP 273, and the RDMA UC QP 274).

As described above, in the example implementation, the per queue context (the RDMA unreliable queue context, e.g., the context 231) for each RDMA unreliable queue pair contains an identifier that links to the common transport context (the RDMA reliable queue pair context 230) corresponding to the reliable connection used to tunnel the unreliable queue pair traffic. In the example implementation, the linked common transport context includes a connection state of the reliable connection, and a tunnel identifier (e.g., a QP ID of the corresponding RC QP 224) that identifies the reliable connection.

The common transport context (e.g,. the reliable queue context 230) manages the RC transport information related to maintaining a reliable delivery channel across the peer (e.g., Packet Sequence Number (PSN), ACK/NAK, Timers, Outstanding Work Request (WR) context, QP/Tunnel state, etc.). As described above, the transport context (e.g., the transport context 232) includes connection context (e.g., the connection context 233). For an RDMA UC queue pair, the connection context maintains the connection parameters and the associated reliable connection tunnel identifier. For an RDMA UD queue pair, the connection context maintains the address handle and the associated reliable connection tunnel identifier. In the example implementation, the reliable connection tunnel identifier is an RC QP ID of the associated RC QP (e.g., the RC QP 224.

### Generic Encapsulation Inside RC Transport

In some embodiments, the adapter device 211 tunnels traffic from protocols other than RDMA through an RC connection (e.g., the RC connection provided by the RDMA RC QP 224), such as, for example, RoCEv2, TCP, UDP and other IP based traffic to be carried over RoCEv2 fabric.

### Disconnecting the Reliable Connection

In the example embodiment, the reliable connection between the adapter device 211 and the different adapter device (e.g, adapter device 501 of remote RDMA system 500) is disconnected based on a configured disconnect policy. The disconnection is performed responsive to a disconnect request initiated by the owner of the reliable connection. In an implementation in which the host processing unit 399 executes instructions of the RDMA hypervisor driver 216 to create the reliable connection, the host processing unit 399 is the owner of the reliable connection. In an implementation in which the adapter device processing unit 225 executes instructions of the RDMA firmware module 227 to create the reliable connection, the adapter device processing unit 225 is the owner of the reliable connection.

In the example embodiment, the owner of the reliable connection (e.g., provided by the RC QP 224) monitors usage of the reliable connection (e.g., traffic communicated over the reliable connection). In an implementation, the owner of the reliable connection obtains usage data of the reliable connection by querying an interface of the reliable connection (e.g., by querying an interface of the RC QP 224). For example, the owner of the reliable connection can query the RC QP 224 to determine when the last packet was transmitted or received over the reliable connection. In an implementation, the owner of the reliable connection obtains usage data of the reliable connection by receiving an async (asynchronous) CQE from the RC QP of the reliable communication (e.g., the RC QP 224) based on at least one of a timer or a packet-based policy. For example, the RC QP of the reliable connection can provide the owner of the reliable connection with an async CQE periodically, and the async CQE can include an activity count that indicates a number of packets transmitted and/or received since the RC QP provided the last async CQE to the owner.

Based on the disconnect policy and the obtained usage data of the reliable connection, the owner of the reliable connection determines whether to issue the reliable connection disconnect request.

Responsive to disconnection, the owner of the reliable connection updates the connection context 223 for the reliable connection. More specifically, the owner of the reliable connection updates the connection context for the reliable connection to indicate an invalid tunnel identifier.

Responsive to reception of a new request after the reliable connection is disconnected, a reliable connection is created as described above for FIG. 5.

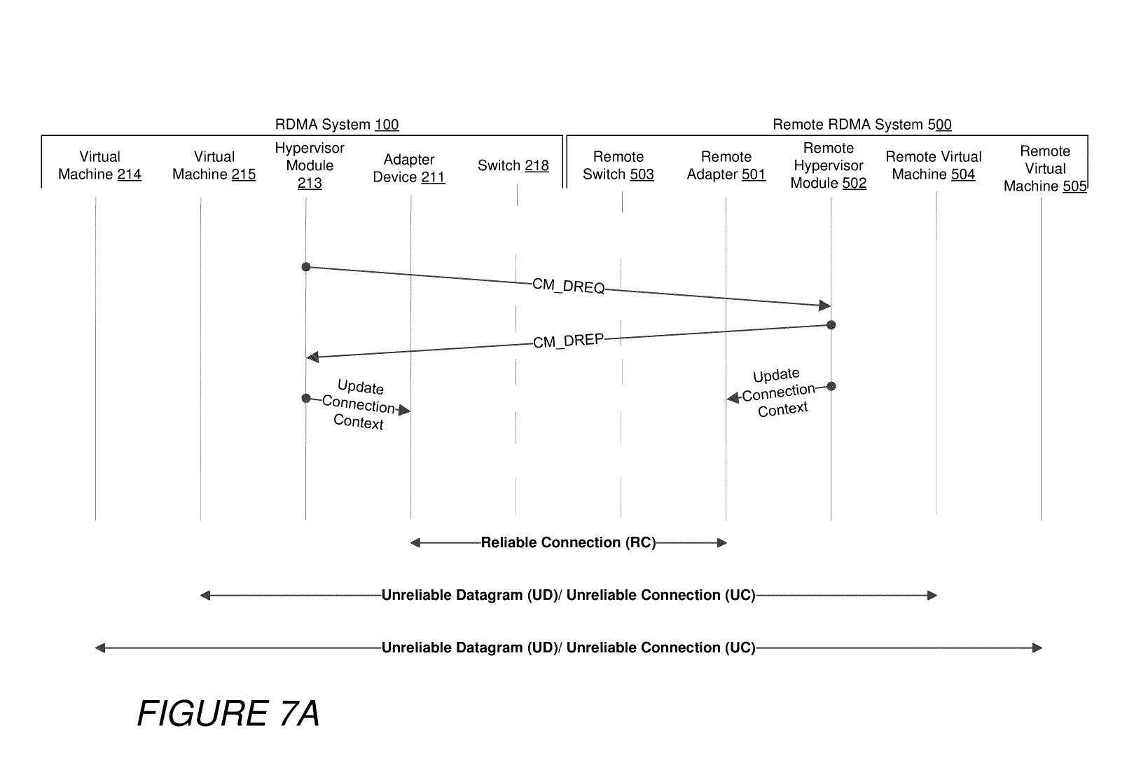

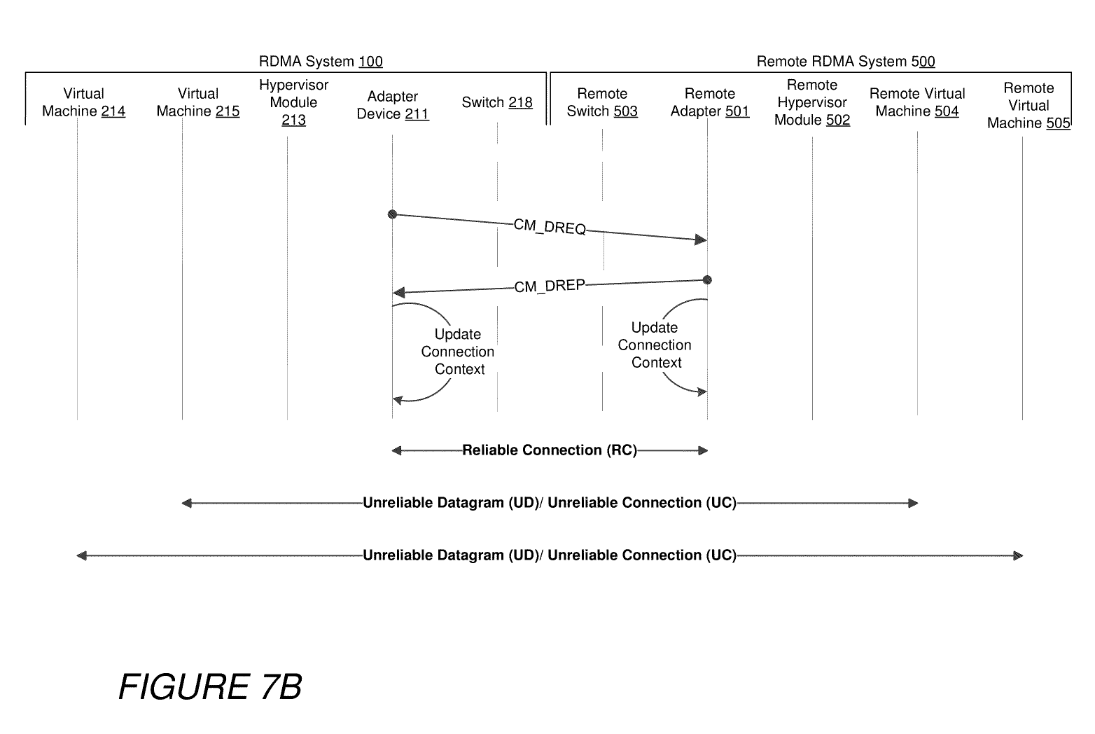

FIG. 7A is a sequence diagram depicting disconnection of a reliable connection in a case where the host processing unit 399 is the owner of the reliable connection. As shown in FIG. 7A, in the example implementation the hypervisor module 213 initiates disconnection by sending an INFINIBAND “CM_DREQ” (Disconnection REQuest) message to the remote hypervisor module 502. Responsive to the “CM_DREQ” message, the remote hypervisor module 502 updates connection context in the remote adapter device 501 and sends an INFINIBAND “CM_DREP” (Reply to Disconnection REQuest) message to the hypervisor module 213. Responsive to the “CM_DREP” message, the hypervisor module 213 updates connection context in the adapter device 211.

FIG. 7B is a sequence diagram depicting disconnection of a reliable connection in a case where the adapter device processing unit 225 is the owner of the reliable connection. As shown in FIG. 7B, in the example implementation the adapter device 211 initiates disconnection by sending an INFINIBAND “CM_DREQ” (Disconnection REQuest) message to the remote adapter device 501. Responsive to the “CM_DREQ” message, the remote adapter device 501 updates connection context in the remote adapter device 501 and sends an INFINIBAND “CM_DREP” (Reply to Disconnection REQuest) message to the adapter device 211. Responsive to the “CM_DREP” message, the adapter device 211 updates connection context in the adapter device 211.

Embodiments of the invention are thus described. While embodiments of the invention have been particularly described, they should not be construed as limited by such embodiments, but rather construed according to the claims that follow below.

While certain exemplary embodiments have been described and shown in the accompanying drawings, it is to be understood that such embodiments are merely illustrative of and not restrictive on the broad invention, and that the embodiments of the invention not be limited to the specific constructions and arrangements shown and described, since various other modifications may occur to those ordinarily skilled in the art.

When implemented in software, the elements of the embodiments of the invention are essentially the code segments to perform the necessary tasks. The program or code segments can be stored in a processor readable medium or transmitted by a computer data signal embodied in a carrier wave over a transmission medium or communication link. The “processor readable medium” may include any medium that can store information. Examples of the processor readable medium include an electronic circuit, a semiconductor memory device, a read only memory (ROM), a flash memory, an erasable programmable read only memory (EPROM), a floppy diskette, a CD-ROM, an optical disk, a hard disk, etc. The computer data signal may include any signal that can propagate over a transmission medium such as electronic network channels, optical fibers, air, electromagnetic, RF links, etc. The code segments may be downloaded via computer networks such as the Internet, Intranet, etc.

### CONCLUSION

While this specification includes many specifics, these should not be construed as limitations on the scope of the disclosure or of what may be claimed, but rather as descriptions of features specific to particular implementations of the disclosure. Certain features that are described in this specification in the context of separate implementations may also be implemented in combination in a single implementation. Conversely, various features that are described in the context of a single implementation may also be implemented in multiple implementations, separately or in sub-combination. Moreover, although features may be described above as acting in certain combinations and even initially claimed as such, one or more features from a claimed combination may in some cases be excised from the combination, and the claimed combination may be directed to a sub-combination or variations of a sub-combination. Accordingly, the claimed invention is limited only by patented claims that follow below.

What is claimed is:

1. An adapter device comprising:
an adapter device processing unit storing:
remote direct memory access (RDMA) reliable queue context for one RDMA RC queue pair of the adapter device, the RDMA RC queue pair providing a reliable connection between the adapter device and a different adapter device, and
RDMA unreliable queue context for one or more RDMA unreliable queue pairs of the adapter device; and
an RDMA firmware module that includes instructions that when executed by the adapter device processing unit cause the adapter device to initiate the reliable connection between the adapter device and the different adapter device, and tunnel packets of the one or more RDMA unreliable queue pairs through the reliable connection by using the RDMA reliable queue context and the RDMA unreliable queue context.

2. The adapter device of claim 1, wherein the RDMA unreliable queue pairs include at least one of RDMA unreliable connection (UC) queue pairs and RDMA unreliable datagram (UD) queue pairs.

3. The adapter device of claim 1, wherein the reliable queue context includes transport context for all unreliable RDMA traffic between one or more RDMA unreliable queue pairs of the adapter device and one or more RDMA unreliable queue pairs of the different adapter device.

4. The adapter device of claim 3, wherein the transport context includes connection context for the reliable connection.

5. The adapter device of claim 1, wherein the reliable connection is an RC tunnel for tunneling unreliable RDMA traffic between one or more RDMA unreliable queue pairs of the adapter device and one or more RDMA unreliable queue pairs of the different adapter device.

6. The adapter device of claim 1, wherein the adapter device further comprises:
an RDMA transport context module constructed to manage the RDMA reliable queue context; and
an RDMA queue context module constructed to manage the RDMA unreliable queue context,
wherein the adapter device processing unit uses the RDMA transport context module to access the RDMA reliable queue context and uses the RDMA queue context module to access the unreliable queue context during tunneling of packets through the reliable connection.

7. The adapter device of claim 1, wherein each tunneled RDMA unreliable queue pair packet includes a tunnel header that includes an adapter device opcode that indicates that the packet is tunneled through the reliable connection, and includes information for the reliable connection.

8. The adapter device of claim 7, wherein the tunnel header includes a queue pair identifier of an RDMA RC queue pair of the different adapter device.

9. The adapter device of claim 1, wherein the RDMA unreliable queue context for each RDMA unreliable queue pair contains an identifier that links to the RDMA reliable queue context, wherein the RDMA reliable queue context includes a connection state of the reliable connection, and a tunnel identifier that identifies the reliable connection.

10. The adapter device of claim 9,
wherein RDMA reliable queue context corresponding to an RDMA UC queue pair includes connection parameters for an unreliable connection of the RDMA UC queue pair,
wherein RDMA reliable queue context corresponding to a RDMA UD queue pair includes a destination address handle of the RDMA UD queue pair, and
wherein the tunnel identifier is a queue pair identifier of the RDMA RC queue pair.

11. The adapter device of claim 9, wherein the RDMA unreliable queue context for each RDMA unreliable queue pair contains a send queue index, a receive queue index, RDMA protection domain queue key, completion queue element (CQE) generation information, and event queue element (EQE) generation information.

12. The adapter device of claim 1, wherein the RDMA unreliable queue context for each RDMA unreliable queue pair contains requestor error information and responder error information.

13. A method comprising:
initiating a remote direct memory access (RDMA) reliable connection (RC) between a first RDMA RC queue pair of a first adapter device and a second RDMA RC queue pair of a second adapter device; and
storing in the first adapter device:
RDMA reliable queue context for the first RDMA RC queue pair, and
RDMA unreliable queue context for one or more RDMA unreliable queue pairs of the first adapter device; and
tunneling packets of the one or more RDMA unreliable queue pairs for the first adapter device through the RDMA reliable connection by using the RDMA reliable queue context and the RDMA unreliable queue context.

14. The method of claim 13, wherein the RDMA unreliable queue pairs include at least one of RDMA unreliable connection (UC) queue pairs and RDMA unreliable datagram (UD) queue pairs.

15. The method of claim 13,
wherein the reliable queue context includes transport context for all unreliable RDMA traffic between one or more RDMA unreliable queue pairs of the first adapter device and one or more RDMA unreliable queue pairs of the second adapter device, and
wherein the transport context includes connection context for the reliable connection.

16. The method of claim 13, wherein each tunneled RDMA unreliable queue pair packet includes a tunnel header that includes an adapter device opcode that indicates that the packet is tunneled through the reliable connection, and includes information for the reliable connection.

17. The method of claim 16, wherein the tunnel header includes a queue pair identifier of the second RDMA RC queue pair of the second adapter device.

18. The method of claim 13, wherein the RDMA unreliable queue context for each RDMA unreliable queue pair contains an identifier that links to the RDMA reliable queue context, wherein the RDMA reliable queue context includes a connection state of the reliable connection, and a tunnel identifier that identifies the reliable connection.

19. The method of claim 18,
wherein RDMA reliable queue context corresponding to an RDMA UC queue pair includes connection parameters for an unreliable connection of the RDMA UC queue pair,
wherein RDMA reliable queue context corresponding to a RDMA UD queue pair includes a destination address handle of the RDMA UD queue pair, and
wherein the tunnel identifier is a queue pair identifier of the first RDMA RC queue pair.

20. A non-transitory storage medium storing processor-readable instructions comprising:
initiating a remote direct memory access (RDMA) reliable connection (RC) between a first RDMA RC queue pair of a first adapter device and a second RDMA RC queue pair of a second adapter device; and
storing in the first adapter device:
RDMA reliable queue context for the first RDMA RC queue pair, and
RDMA unreliable queue context for one or more RDMA unreliable queue pairs of the first adapter device; and
tunneling packets of the one or more RDMA unreliable queue pairs for the first adapter device through the RDMA reliable connection by using the RDMA reliable queue context and the RDMA unreliable queue context.
